(19) United States
(12) Patent Application Publication
(10) Pub. No.: US 2004/0068885 A1
(43) Pub. Date: Apr. 15, 2004

(54) Tape measure recording device

(76) Inventor: Richard Rubin, Danbury, CT (US)

Correspondence Address: DICKSTEIN SHAPIRO MORIN & OSHINSKY LLP, 1177 AVENUE OF THE AMERICAS, NEW YORK, NY, 10038-2714, US

(21) Appl. No.: 10/268,214

(22) Filed: Oct. 10, 2002

(51) Int. Cl. G01B 3/10

(52) U.S. Cl. 33/761

(57) ABSTRACT

The present invention relates to erasable work boards. More particularly it relates to specially designed erasable whiteboards that can be secured onto a multiplicity of differently sized tape measuring devices. The object of the present invention is to provide the ability to the user to customize any tape measure with an easily mounted work board for notes, lists or measurements.

### FIELD OF THE INVENTION

The present invention relates to erasable whiteboards and, more particularly, to a new erasable whiteboard that can be conveniently mounted onto a tape measure.

### DESCRIPTION OF THE PRIOR ART

A white laminate display panel commonly known as a “whiteboard” has all but replaced the classic chalkboard (a.k.a. blackboard) everywhere from classrooms to boardrooms. Like a chalkboard, use of a whiteboard involves writing on the board that can later be erased, allowing reuse of the board indefinitely. This writing is accomplished with a standard carpenter's pencil or, if preferred, by using a pen containing ink specially formulated for quick drying and the ability to be easily erased. Erasure is much easier than a chalkboard, often able to be done with just a finger, thus making whiteboards ideal for rapidly changing notes or figures such as measurements.

Tape measures are compact and portable devices of varying size and shape used for measuring lengths. Often many lengths are measured simultaneously making it desirable to write down these various lengths to avoid confusion. Whiteboards are ideal for such notes but are usually too large and cumbersome for most workshops or construction sites. Thus, it is desirable to have whiteboards of various small sizes that can easily be attached to varying sizes of tape measures.

Numerous innovations for whiteboards have been provided in the prior art that are described as follows. Even though these innovations may be suitable for the specific individual purposes to which they address, they differ from the present invention as hereafter contrasted.

U.S. Pat. No. 5,518,217 to Deutsch, et al discloses a stackable whiteboard with collapsible legs and a pad holder. This patent differs from the present invention because it is too large and is free standing instead of small and adhesively mounted.

U.S. Pat. No. 6,353,193 to Atwood, et al discloses an electronic whiteboard system and method This patent differs from the present invention because it is too large, complex and cannot be mounted onto a tape measurer.

U.S. Pat. No. 6,171,173 to Alcala, et al discloses a toy refrigerator having an activity surface, such as a whiteboard. This patent differs from the present invention because it is too large and is designed as a children's toy. It is not practical as a work aid.

Numerous innovations for whiteboards have been provided in the prior art that are adapted to be used. Even though these innovations may be suitable for the specific purposes to which they address, they would not be suitable for the purposes of the present invention as heretofore described.

### SUMMARY OF THE INVENTION

The present invention describes a white laminate display work board commonly known as a “whiteboard” that can be easily attached to a multiplicity of differently sized tape measures.

Tape measures are commonly used to measure a multiplicity of lengths both simultaneously and consecutively. These lengths need to be written down to avoid confusion and to be accurately remembered. Because such notes are constantly changing as new measurements are taken, an easily erasable surface such as a whiteboard is ideal. Most whiteboards are too large and cumbersome to be useful, thus it is desirable to have whiteboards of various small sizes that can be easily attached to any size tape measure.

This invention enables users to have a convenient notepad always on hand that is cost-effective and can be attached to any old, new or used tape measure with ease This concept provides for flexibility, by working around the basic architecture of any tape measure. The present invention involves three sizes of work boards made of finished PVC and can be applied to any tape measure with the provided clear heavy-duty mounting tape. The advantage of the present invention is that it is small, easily portable, and can be reused for notes or calculations indefinitely. It can be used on the work site, in the shop or at home. The user can write down measurements or lists and then quickly erase them with a thumb or finger when they are no longer needed.

Anyone who uses a tape measure should find this invention an ideal alternative to pencils, paper and easily misplaced lists and notes on measurements.

Accordingly, it is the object of the present invention to provide the ability to a user to customize any tape measure with an easily mounted work board for notes, lists or measurements.

More particularly, it is an object of the present invention to provide three sizes of work boards that can be easily adapted and applied to almost any size and brand of tape measure.

In keeping with these objects, and with others, which will become apparent hereinafter, one feature of the present invention, briefly stated, is efficient and organized use of space for notes.

When the present invention is properly used the notes and measurements can be changed in seconds.

In accordance with another feature of the present invention, it can be applied to almost any size tape measure within seconds by simply pealing the adhesive tape backing, lining up the whiteboard to the tape measure and applying.

Another feature of the present invention is that the work boards are small and can be easily applied anywhere needed for notes, lists or measurements that can be quickly erased and rewritten.

Still another feature of the present invention is that it greatly increases the efficiency and organization of any workspace.

It should be understood that while the above and other advantages and results of the present invention will become apparent to those skilled in the art from the detailed description and accompanying drawings, showing the contemplated novel construction, combinations and elements herein described, and more defined by the appended claims, it is understood that changes in the precise embodiments of the herein disclosed invention are meant to be included within the scope of the claims, except insofar as they may be precluded by the prior art.

The novel features which are considered for the invention are set forth in the appended claims. The invention itself, however, both as to its construction and its method of operation, together with additional objects and advantages thereof, will best be understood in connection with the accompanying drawings.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a true scale drawing of the three work board sizes.

FIG. 2 is a side view of a work board that is approximately one eighth of an inch thick and also the heavy duty mounting tape.

FIG. 3 is an example of a work board mounted on a tape measure.

FIGS. 4, 5, and 6 are front views of the invention applied on different size tape measures.

### DETAILED DESCRIPTION

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

The present invention is a white laminate display panel commonly known as a whiteboard that can be easily attached to a multiplicity of differently sized tape measures. The essential part of the invention is the varied sizes of whiteboard, shaped for a perfect fit on a multiplicity of tape measures combined with the quick and efficient securing device that is the heavy duty mounting tape.

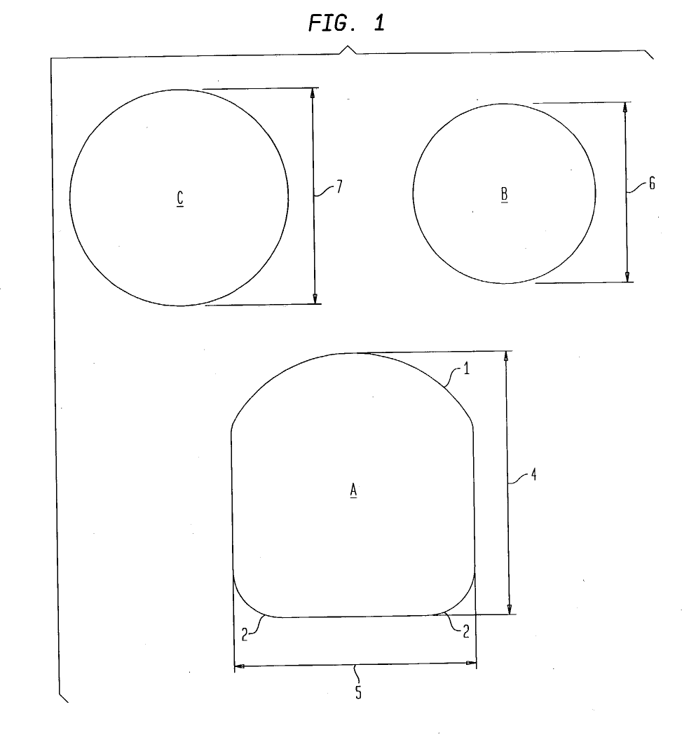

FIG. 1 is a true scale drawing of the present invention in three size and shape embodiments. The large white board (A) is a rounded edge square shape with an arched topside (1) and two rounded corners on the bottom side (2). The height of said white board is 2 and ¾ inches (4) while the width is 2 and ½ inches (5). This large size white board is perfectly sized for almost any large tape measure. The medium size white board (C) is a circular disk shape that is 2 and 5/16 inches in diameter (7) and is perfectly sized for a mid-sized tape measure. The smallest white board (B) is also a circular disk shape and is 1 and 15/16 inches in diameter (6) and is perfectly sized for the smallest tape measures.

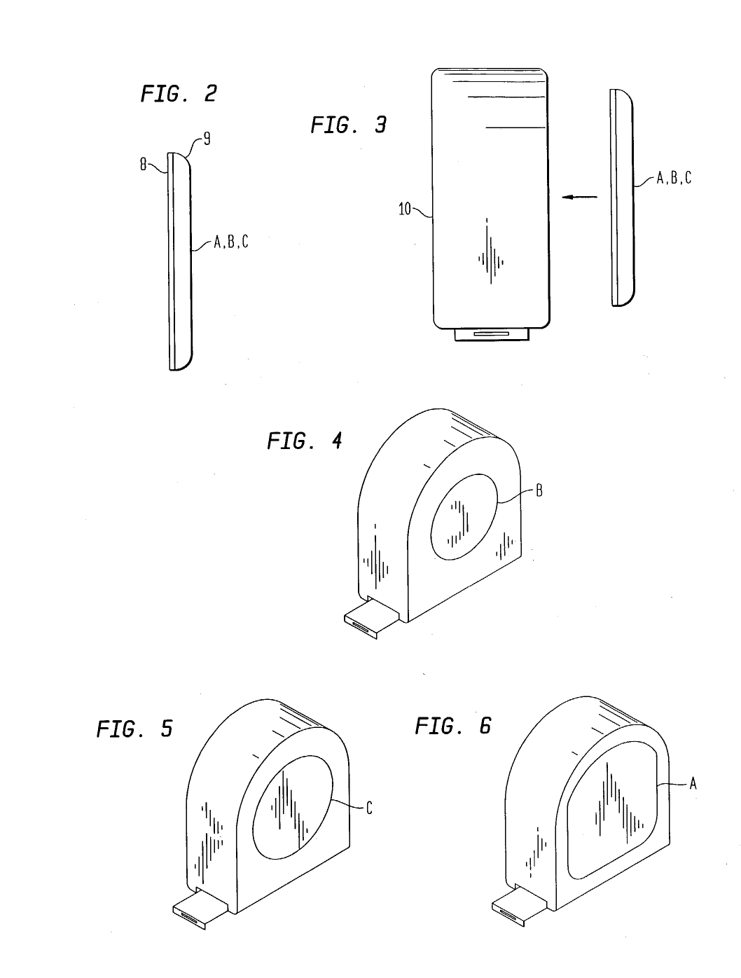

FIG. 2 is the side view of a white board (9) of any of the three sizes (A, B, or C) and is approximately ⅛^{th} of an inch thick. Also shown is the heavy duty mounting tape (8) that serves as the securing device to attach the white board to the tape measure.

FIG. 3 is a side view of a tape measure (10) and the securing point of any of the three sizes of white board (A, B, or C).

FIG. 4 is an angled front view of the present invention in its smallest embodiment (B) applied on the smallest size of tape measure.

FIG. 5 is an angled front view of the present invention in its mid-sized embodiment (C) applied on a medium sized tape measure.

FIG. 6 is an angled front view of the present invention in its largest embodiment (A) applied on an extra large tape measure.

The foregoing disclosure and description of the invention is illustrative and exemplary therefore and various changes in the size, shape and materials, as well as in the details of the illustrated constructions may be made within the scope of the appended claims without departing from the spirit of the invention.

I claim:

1. A method for providing a whiteboard work surface on various types and sizes of measuring tapes for the purpose of recording information on the measuring tape, the method comprising the steps of:
fabricating whiteboards of various types and sizes suitable for attachment to various types and sizes of measuring tapes;
attaching mounting adhesive means to the rear portion of the whiteboard; and
adhesively attaching the whiteboard to the measuring tape.

2. A method in accordance with claim 1, wherein the whiteboard is attached to a side of the measuring tape.

3. A method in accordance with claim 2, wherein said white board is comprised of finished PVC.

4. A method in accordance with claim 2, wherein said whiteboard is fabricated into a plurality of distinct shapes and sizes.

5. A securable measuring tape work board, comprising a whiteboard which can be applied to any size or type of measuring tape using adhesive means.
